(19) United States
(12) Patent Application Publication
(10) Pub. No.: US 2014/0065338 A1
(43) Pub. Date: Mar. 6, 2014

(54) MONOLAYER TUBES COMPRISING THERMOPLASTIC POLYAMIDE

(71) Applicants: SHAILESH RATILAL DOSHI, Kingston (CA); Marvin M. Martens, Bettendorf, IA (US); Anna Kutty Mathew, Kingston (CA); Georgios Topoulos, Meyrin (CH)

(72) Inventors: SHAILESH RATILAL DOSHI, Kingston (CA); Marvin M. Martens, Bettendorf, IA (US); Anna Kutty Mathew, Kingston (CA); Georgios Topoulos, Meyrin (CH)

(73) Assignee: E I DU PONT DE NEMOURS AND COMPANY, Wilmington, DE (US)

(21) Appl. No.: 13/596,220

(22) Filed: Aug. 28, 2012

(51) Int. Cl. C08G 69/26

(52) U.S. Cl. 428/36.9

(57) ABSTRACT

Disclosed is a monolayer tube comprising a melt-blended thermoplastic composition consisting essentially of (A) a polyamide resin selected from the group consisting of PA 614, PA 616, PA 618 and blends of these; and optionally: (B) one or more polymeric toughener(s); (C) one or more plasticizer(s); and (D) one or more functional additive(s); wherein the weight percent of (A), (B), (C), and (D) are based on the total weight of the melt-blended thermoplastic composition.

### FIELD OF THE INVENTION

The present invention relates to the field of monolayer tubing comprising polyamide compositions.

### BACKGROUND OF INVENTION

Polymeric materials, including thermoplastics and thermosets, are used extensively as automotive components and as molded articles for various other applications. They are light weight and relatively easy to mold into complex parts, and are therefore preferred over metals in many such applications. However, a problem encountered by some polymers is salt stress (induced) corrosion cracking (SSCC), where a polymeric part in stress undergoes accelerated corrosion when exposed to inorganic salts. This often results in cracking and premature failure of the molded parts. Polymeric molded parts may also need to exhibit significant high durability and toughness under use conditions.

Polyamides, such as polyamide 66, polyamide 6, polyamide 610 and polyamide 612 have been made into and used as vehicular interior and exterior components and in the form of other parts. While it has been reported that polyamides 610 and 612 are satisfactorily resistant to SSCC (see for instance Japanese Patent 3271325B2), all of these polyamides are prone to SSCC in such uses, because for instance, various sections of vehicles and their components are sometimes exposed to salts, for example sodium chloride or calcium chloride, used to melt snow and ice in colder conditions. Corrosion of metallic parts such as fittings and frame components made from steel and various iron based alloys in contact with water and road salts can also lead to formation of salts. These salts, in turn, can further attack the polyamide based automotive parts, making them susceptible to SSCC. Thus polyamide compositions with improved resistance to SSCC are desired.

U.S. Pat. No. 4,076,664 discloses a terpolyamide resin that has favorable resistance to zinc chloride.

US 2005/0234180 discloses a resin molded article having an excellent snow melting salt resistance, said article comprising 1 to 60% by weight of aromatic polyamide resin.

Furthermore, increasing fossil raw material prices and to reduce greenhouse gas emissions to environment make it desirable to develop engineering polymers from linear, long chain dicarboxylic acids prepared from renewable feedstocks. As such, there is a demand for renewable bio-based polymers having similar or better performance characteristics than petrochemical-based polymers. As example, renewable nylon materials such as PA 610 are based on ricinoleic acid derived sebacic acid (C10). However, ricinoleic acid production requires the processing of castor beans and involves the handling of highly allergenic materials and highly toxic ricin. Moreover, the production of sebacic acid is further burdened with high consumption of energy and with the formation of a large amount of salts as by products associated with other byproducts.

WO 2010/068904 discloses a method to produce renewable alkanes from biomass based triacylglycerides in high yield and selectivity and their subsequent fermentation to renewable diacids. Such naturally occurring triacylglycerides, also referred to as oils and fats, are composed of a glycerol backbone esterified with three fatty acids of a variety of chain lengths specific to the type of fats and oils. Most abundant amongst vegetable oils are triacylglycerides based on C12, 14, 16 and C18 fatty acids. Several vegetable oils are rich in C12, C14, C16 and C18 fatty esters including soybean oil, palm oil, palm kernel oil, sunflower oil, olive oil, cotton seed oil, rape seed oil, and corn oil (Ullmann's Encyclopedia of Technical Chemistry, A. Thomas: “Fats and Fatty Oils” (2005 Wiley-VCH Verlag GmbH & Co. KGaA, Weinheim, electronic version, 10.1002/14356007.a10 173). As such, dioic acid streams based on the oxidative fermentation of renewable alkanes derived from such oils, being rich in C16 and C18 dioic acids, may be useful in formation of economically attractive polymers.

The vegetable oils contain usually at most 50% C12 components (Ullman ref.), hence other diacid components are usually separated out from the mixture of acids and used for other purposes. In order to improve the economics of renewable diacids processes based on triacylglyceride hydrogenation and fermentation of the resulting n-alkanes, it is desirable to include all long chain diacid components into polyamide chains. Hence, developing sustainable compositions of renewable polyamide copolymers, that meet or exceed the performance requirement of existing commercial long chain polyamide compositions at competitive cost is a highly desirable goal.

US patent publication 20011/0220236 A1 discloses a two-layered plastic tubing, the outer layer formed from a mixture comprising a homopolyamide. Preferred homopolyamides are PA 612, PA 610, PA 614 and PA 616.

U.S. Pat. No. 7,858,165 B2 discloses a multi-layer tube including an intermediate layer including a polyamide of formula X,Y/Z in which X denotes residues of an aliphatic diamine having 6 to 10 carbon atoms, and Y denotes residues of an aliphatic dicarboxylic acid having from 10 to 14 carbon atoms; and Z is an optional lactam or amino carboxylic acid.

Chinese Patent application 200810035154 discloses a monolayer tube of aliphatic long-chain polyamide. Disclosed is a polyamide including long chain diamine with 10 to 12 carbon atoms and long-chain diacid with 8 to 10 methylene atoms.

### SUMMARY OF THE INVENTION

Disclosed is a monolayer tube, preferably for transferring liquids and/or gases, comprising a melt-blended thermoplastic composition consisting essentially of
(A) 40 to 100 weight percent of a polyamide resin selected from the group consisting of poly(hexamethylene tetradecanediamide), poly(hexamethylene hexadecanediamide), poly(hexamethylene octadecanediamide), and blends of these;
(B) 0 to 30 weight percent of one or more polymeric toughener(s);
(c) 0 to 20 weight percent, of one or more plasticizer(s);
(D) 0 to 10 weight percent of one or more functional additive(s);

wherein the weight percent of (A), (B), (C), and (D) are based on the total weight of the melt-blended thermoplastic composition.

### BRIEF DESCRIPTION OF FIGURES

FIG. 1 shows a dynamic mechanical analysis of a crystalline copolymer.

### DETAILED DESCRIPTION OF THE INVENTION

Herein melting points are as determined using differential scanning calorimetry (DSC) at a scan rate of 10° C./min in the first heating scan, wherein the melting point is taken at the maximum of the endothermic peak, and the heat of fusion in Joules/gram (J/g) is the area within the endothermic peak.

Herein freezing points are as determined with DSC in the cooling cycle at a scan rate of 10° C./min carried out after the first heating cycle as per ASTM D3418.

Herein the term delta melting point minus freezing point (MP-FP, in ° C.) is the difference between the melting point and freezing point of a particular polymer or copolymer, wherein the melting point and freezing point are determined as disclosed above. The term delta MP-FP is one measure of the crystallinity of polymer or copolymer and, in part, determines the crystallization kinetics of the polymer or copolymer. A low delta MP-FP typically gives high crystallization rates; and faster cycle times in injection molding process. A low delta MP-FP typically gives desirable high temperature properties in extrusion processing as well.

Dynamic mechanical analysis (DMA) is used herein for determination of storage modulus (E′) and loss modulus (E″), and glass transition, as a function of temperature. Tan delta is a curve resulting from the loss modulus divided by the storage modulus (E″/E′) as a function of temperature.

Dynamic mechanical analysis is discussed in detail in “Dynamic Mechanical Analysis: A practical Introduction,” Menard K. P., CRC Press (2008) ISBN is 978-1-4200-5312-8. Storage modulus (E′), loss modulus (E″) curves exhibit specific changes in response to molecular transitions occurring in the polymeric material in response to increasing temperature. A key transition is called glass transition. It characterizes a temperature range over which the amorphous phase of the polymer transitions from glassy to rubbery state, and exhibits large scale molecular motion. Glass transition temperature is thus a specific attribute of a polymeric material and its morphological structure. For the co-polyamide compositions disclosed herein, the glass transition occurs over a temperature range of about 20 to about 50° C. The Tan delta curve exhibits a prominent peak in this temperature range. This peak tan delta temperature is defined in the art as the tan delta glass transition temperature, and the height of the peak is a measure of the crystallinity of the polymeric material. A polymeric sample with low or no crystallinity exhibits a tall tan delta peak due to large contribution of the amorphous phase molecular motion, while a sample with high level of crystallinity exhibits a smaller peak because molecules in crystalline phase are not able to exhibit such large scale rubbery motion. Thus, herein the value of tan delta glass transition peak is used as a comparative indicator of level of crystallinity in the co-polyamides and melt-blended thermoplastic polyamide compositions.

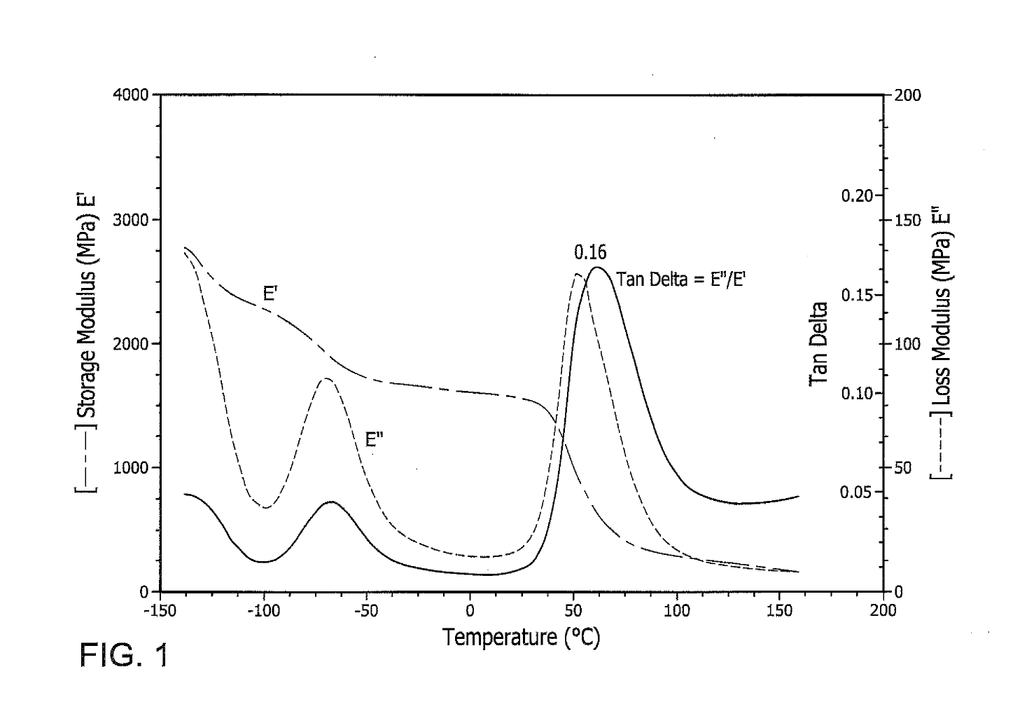

FIG. 1 shows a dynamic mechanical analysis of a crystalline co-polymer showing the storage modulus (E′), loss modulus (E″) curves and computed tan delta curve (E″/E′). A higher tan delta peak corresponds to lower crystallinity and conversely, a lower tan delta peak corresponds to higher crystallinity; as discussed in “Thermal Analysis of Polymers,” Sepe M. P., Rapra Review Reports, Vol. 8, No. 11 (1977).

The term “consisting of” means the embodiment necessarily includes the listed components only and no other unlisted components are present. Herein, for instance, the term as applied to the polyamide resin means the polyamide resin includes the stated repeat unit, and does not include any other repeat units.

The term “consisting essentially of” means the embodiment necessarily includes the listed components only but may also include additional unnamed, unrecited elements, which do not materially affect the basic and novel characteristic of the composition. Herein, for instance, the term as applied to polyamide resin means the polyamide includes the stated repeat unit, but may include any other repeat units in amounts less than 10 mole percent, and preferably less than 3 mole percent, and which do not affect the novel characteristics of the resin as practiced in the monolayer tube.

Component (A) is 40 to 100 weight percent of a polyamide resin selected from the group consisting of poly(hexamethylene tetradecanediamide) (PA614), poly(hexamethylene hexadecanediamide) (PA616) and poly(hexamethylene octadecanediamide) (PA618).

One embodiment is a monolayer tube wherein said polyamide resin is poly(hexamethylene tetradecanediamide).

Another embodiment is a monolayer tube wherein said polyamide resin is poly(hexamethylene hexadecanediamide).

Another embodiment is a monolayer tube wherein said polyamide resin is poly(hexamethylene octadecanediamide).

In other embodiments the monolayer tubes comprise a thermoplastic composition, as disclosed above, having a salt stress crack resistance of at least 144 hours without failure, as measured with a modified ASTM D1693 method, with the modifications being that 50 weight percent zinc chloride solution is used as the reagent, the test is conducted at 50° C., and rectangular test pieces measuring 50 mm×12 mm×3.2 mm being used. The salt stress crack resistance method is further disclosed in the Methods Section.

The polyamides of the invention are preferably prepared from aliphatic dioic acids and aliphatic diamines, at least one of which is bio-sourced or “renewable”. By “bio-sourced” is meant that the primary feed-stock for preparing the dioic acid and/or diamine is a renewable biological source, for instance, vegetable matter including grains, vegetable oils, cellulose, lignin, fatty acids; and animal matter including fats, tallow, oils such as whale oil, fish oils, and the like. These bio-sources of dioic acids and aliphatic diamines have a unique characteristic in that they all possess high levels of the carbon isotope ¹⁴C (carbon pools having an elevated content of ¹⁴C are sometimes referred to as “modern carbon”); as compared to fossil or petroleum sources of the dioic acids and aliphatic diamines. This unique isotope feature remains unaffected by non-nuclear, conventional chemical modifications. Thus the ¹⁴C isotope level in bio-sourced materials provides an unalterable feature that allows any downstream products, such as polyamides; or products comprising the polyamides, to be unambiguously identified as comprising a bio-sourced material. Furthermore, the analysis of ¹⁴C isotope level in dioic acids, diamines and downstream product is sufficiently accurate to verify the percentage of bio-sourced carbon in the downstream product.

Component (B) is 0 to 30 weight percent of one or more polymeric toughener(s). A polymeric toughener is a polymer, typically an elastomer having a melting point and/or glass transition points below 25° C., or is rubber-like, i.e., has a heat of melting (measured by ASTM Method D3418-82) of less than about 10 J/g, more preferably less than about 5 J/g, and/or has a melting point of less than 80° C., more preferably less than about 60° C. Preferably the polymeric toughener has a weight average molecular weight of about 5,000 or more, more preferably about 10,000 or more, when measured by gel permeation chromatography using polyethylene standards.

The polymeric toughener can be a functionalized toughener, a nonfunctionalized toughener, or blend of the two.

A functionalized toughener has attached to it reactive functional groups which can react with the polyamide. Such functional groups are usually “attached” to the polymeric toughener by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber (such as an ethylene/α-olefin copolymer, an α-olefin being a straight chain olefin with a terminal double bond such a propylene or 1-octene) using free radical grafting techniques. The resulting grafted polymer has carboxylic anhydride and/or carboxyl groups attached to it.

Ethylene copolymers are an example of a polymeric toughening agent wherein the functional groups are copolymerized into the polymer, for instance, a copolymer of ethylene and a (meth)acrylate monomer containing the appropriate functional group. Herein the term (meth)acrylate means the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl (meth)acrylate. In addition to ethylene and a functionalized (meth)acrylate monomer, other monomers may be copolymerized into such a polymer, such as vinyl acetate, unfunctionalized (meth)acrylate esters such as ethyl (meth)acrylate, n-butyl (meth)acrylate, i-butyl (meth)acrylate and cyclohexyl (meth)acrylate. Polymeric tougheners include those listed in U.S. Pat. No. 4,174,358, which is hereby incorporated by reference.

Another functionalized toughener is a polymer having carboxylic acid metal salts. Such polymers may be made by grafting or by copolymerizing a carboxyl or carboxylic anhydride containing compound to attach it to the polymer. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

Polymeric tougheners useful in the invention include those selected from the group consisting of linear low density polyethylene (LLDPE) or linear low density polyethylene grafted with an unsaturated carboxylic anhydride, ethylene copolymers; ethylene/α-olefin or ethylene/α-olefin/diene copolymer grafted with an unsaturated carboxylic anhydride; core-shell polymers, and nonfunctionalized tougheners, as defined herein.

Herein the term ethylene copolymers include ethylene terpolymers and ethylene multi-polymers, i.e. having greater than three different repeat units. Ethylene copolymers useful as polymeric tougheners in the invention include those selected from the group consisting of ethylene copolymers of the formula E/X/Y wherein:

E is the radical formed from ethylene;

X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer;

Y is one or more radicals formed from monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl (meth)acrylate, 2-hydroxyethyl (meth)acrylate, 2-isocyanatoethyl (meth)acrylate and glycidyl vinyl ether; wherein Y is from 0.5 to 35 weight % of the E/X/Y copolymer, and preferably 0.5-20 weight percent of the E/X/Y copolymer, and E is the remainder weight percent and preferably comprises 40-90 weight percent of the E/X/Y copolymer.

It is preferred that the functionalized toughener contain a minimum of about 0.5, more preferably 1.0, very preferably about 2.5 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener. In one embodiment the polymeric toughener comprises about 2.5 to about 10 weight percent of repeat units and/or grafted molecules containing functional groups or carboxylate salts (including the metal).

It has been found that often the toughness of the composition is increased by increasing the amount of functionalized toughener and/or the amount of functional groups and/or metal carboxylate groups. However, these amounts should preferably not be increased to the point that the composition may crosslink (thermoset), especially before the final part shape is attained, and/or the first to melt tougheners may crosslink each other. Increasing these amounts may also increase the melt viscosity, and the melt viscosity should also preferably not be increased so much that molding is made difficult.

Nonfunctionalized tougheners may also be present in addition to a functionalized toughener. Nonfunctionalized tougheners include polymers such as ethylene/α-olefin/diene (EPDM) rubber, polyolefins including polyethylene (PE) and polypropylene, and ethylene/α-olefin (EP) rubbers such as ethylene/1-octene copolymer, and the like such as those commercial copolymers under the ENGAGE® brand from Dow Chemical, Midland Mich. Other nonfunctional tougheners include the styrene-containing polymers including acrylonitrile-styrene copolymer, acrylonitrile-butadiene-styrene copolymer, styrene-isoprene-styrene copolymer, styrene-hydrogenated isoprene-styrene copolymer, styrene-butadiene-styrene copolymer, styrene-hydrogenated butadiene-styrene copolymer, styrenic block copolymer, and polystyrene. For example, acrylonitrile-butadiene-styrene, or ABS, is a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of poly(styrene acrylonitrile).

Other polymeric tougheners useful in the invention are having a (vinyl aromatic comonomer) core comprising an ethylene copolymer as disclosed above, the core optionally cross-linked and optionally containing a vinyl aromatic comonomer, for instance styrene; and a shell comprising another polymer that may include polymethyl methacrylate and optionally contain functional groups including epoxy, or amine. The core-shell polymer may be made up of multiple layers, prepared by a multi-stage, sequential polymerization technique of the type described in U.S. Pat. No. 4,180,529. Each successive stage is polymerized in the presence of the previously polymerized stages. Thus, each layer is polymerized as a layer on top of the immediately preceding stage.

When used, the minimum amount of polymeric toughener is 0.5, preferably 2, and more preferably about 8 weight percent of the melt-blended thermoplastic composition, while the maximum amount of polymeric toughener is about 30 weight percent, preferably about 25 weight percent. It is to be understood than any minimum amount may be combined with any maximum amount to form a preferred weight range.

Useful polymeric tougheners include:
(a) A copolymer of ethylene, glycidyl (meth)acrylate, and optionally one or more (meth)acrylate esters.
(b) An ethylene/α-olefin or ethylene/α-olefin/diene (EPDM) copolymer grafted with an unsaturated carboxylic anhydride such as maleic anhydride.
(c) A copolymer of ethylene, 2-isocyanatoethyl (meth)acrylate, and optionally one or more (meth)acrylate esters.
(d) a copolymer of ethylene and acrylic acid reacted with a Zn, Li, Mg or Mn compound to form the corresponding ionomer.

### Thermal Stabilizers

Component (C) is 0 to 20 weight percent of one or more plasticizer(s).

The plasticizer(s) will preferably be miscible with the polyamide. Examples of suitable plasticizers include sulfonamides, preferably aromatic sulfonamides such as benzenesulfonamides and toluenesulfonamides. Examples of suitable sulfonamides include N-alkyl benzenesulfonamides and toluenesulfonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

Further examples of palsticizers include polyamide oligomers with a number average molecular weight of 800 to 5000 g/mol, as disclosed in U.S. Pat. No. 5,112,908, herein incorporated by reference, and US patent publication 200910131674 A1. Preferred polyamide oligomers have an inherent viscosity less than 0.5.

The plasticizer may be incorporated into the composition by melt-blending the polyamide resin with plasticizer and, optionally, other ingredients, or during polymerization. If the plasticizer is incorporated during polymerization, the polyamide monomers are blended with one or more plasticizers prior to starting the polymerization cycle and the blend is introduced to the polymerization reactor. Alternatively, the plasticizer can be added to the reactor during the polymerization cycle.

When used, the plasticizer will be present in the composition in about 1 to about 20 weight percent, or more preferably in about 6 to about 18 weight percent, or yet more preferably in about 8 to about 15 weight percent, wherein the weight percentages are based on the total weight of the composition.

Component (D) is 0 to 10 weight percent of one or more functional additive(s). Functional additives are materials that provide a specific function known in the art of tube extrusion. Such additives can be added according to the desired properties of the resulting material, and the control of these amounts versus the desired properties is within the knowledge of the skilled artisan. Functional additives include those selected from the group consisting of thermal stabilizers, antistatic agents, blowing agents, lubricants, nucleants, and colorant and pigments.

The thermoplastic composition may include one or more thermal stabilizer(s) selected from the group consisting of polyhydric alcohols having more than two hydroxyl groups and having a number average molecular weight (Mₙ) of less than 2000; one or more polyhydroxy polymer(s) having a number average molecular weight of at least 2000 and selected from the group consisting of ethylene/vinyl alcohol copolymers; co-stabilizer(s) selected from the group consisting of secondary aryl amines and hindered amine light stabilizers (HALS), hindered phenols and mixtures of these; copper salts; and mixtures these.

The thermoplastic composition may comprise 0.1 to 10 weight percent, and preferably 1 to 8 weight percent and 2 to 6 weight percent, of one or more polyhydric alcohols having more than two hydroxyl groups and having a number average molecular weight (Mₙ) of less than 2000 of less than 2000 as determined for polymeric materials with gel permeation chromatography (GPC).

Polyhydric alcohols may be selected from aliphatic hydroxylic compounds containing more than two hydroxyl groups, aliphatic-cycloaliphatic compounds containing more than two hydroxyl groups, cycloaliphatic compounds containing more than two hydroxyl groups, aromatic and saccharides.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the polyhydric alcohol used in the thermoplastic composition is pentaerythritol, dipentaerythritol, tripentaerythritol, di-trimethylolpropane, D-mannitol, D-sorbitol and xylitol. More preferably, the polyhydric alcohol used is dipentaerythritol and/or tripentaerythritol. A most preferred polyhydric alcohol is dipentaerythritol.

The thermoplastic composition may comprise 0.1 to 10 weight percent of at least one polyhydroxy polymer having a number average molecular weight (Mₙ) of at least 2000, selected from the group consisting of ethylene/vinyl alcohol copolymers; as determined for polymeric materials with gel permeation chromatography (GPC). Preferably the polyhydroxy polymer has a Mₙ of 5000 to 50,000.

In one embodiment the polyhydroxy polymer is an ethylene/vinyl alcohol copolymer (EVOH). The EVOH may have a vinyl alcohol repeat content of 10 to 90 mol % and preferably 30 to 80 mol %, 40 to 75 mol %, 50 to 75 mol %, and 50 to 60 mol %, wherein the remainder mel % is ethylene. A suitable EVOH for the thermoplastic composition is Soarnol® A or D copolymer available from Nippon Gosei (Tokyo, Japan) and EVAL® copolymers available from Kuraray, Tokyo, Japan.

The thermoplastic composition may comprise 1 to 10 weight percent; and preferably 1 to 7 weight percent and more preferably 2 to 7 weight percent polyhydroxy polymer based on the total weight of the thermoplastic polyamide composition.

The thermoplastic composition may comprise 0 to 3 weight percent of one or more co-stabilizer(s) having a 10% weight loss temperature, as determined by thermogravimetric analysis (TGA), of greater than 30° C. below the melting point of the polyamide resin, if a melting point is present, or at least 250° C. if said melting point is not present, selected from the group consisting of secondary aryl amines, hindered phenols and hindered amine light stabilizers (HALS), and mixtures thereof.

For the purposes of this invention, TGA weight loss will be determined according to ASTM D 3850-94, using a heating rate of 10° C./min, in air purge stream, with an appropriate flow rate of 0.8 mL/second. The one or more co-stabilizer(s) preferably has a 10% weight loss temperature, as determined by TGA, of at least 270° C., and more preferably 290° C., 320° C., and 340° C., and most preferably at least 350° C.

The one or more co-stabilizers preferably are present from at or about 0.1 to at or about 3 weight percent, more preferably at or about 0.2 to at or about 1.2 weight percent; or more preferably from at or about 0.5 to at or about 1.0 weight percent, based on the total weight of the thermoplastic composition.

Secondary aryl amines useful in the invention are high molecular weight organic compound having low volatility. Preferably, the high molecular weight organic compound will be selected from the group consisting of secondary aryl amines further characterized as having a molecular weight of at least 260 g/mol and preferably at least 350 g/mol, together with a 10% weight loss temperature as determined by thermogravimetric analysis (TGA) of at least 290° C., preferably at least 300° C., 320° C., 340° C., and most preferably at least 350° C.

By secondary aryl amine is meant an amine compound that contains two carbon radicals chemically bound to a nitrogen atom where at least one, and preferably both carbon radicals, are aromatic. Preferably, at least one of the aromatic radicals, such as, for example, a phenyl, naphthyl or heteroaromatic group, is substituted with at least one substituent, preferably containing 1 to about 20 carbon atoms.

Examples of suitable secondary aryl amines include 4,4′di(α,α-dimethylbenzyl)diphenylamine available commercially as Naugard 445 from Uniroyal Chemical Company, Middlebury, Conn.; the secondary aryl amine condensation product of the reaction of diphenylamine with acetone, available commercially as Aminox from Uniroyal Chemical Company; and para-(paratoluenesulfonylamido) diphenylamine also available from Uniroyal Chemical Company as Naugard SA. Other suitable secondary aryl amines include N,N′-di-(2-naphthyl)-p-phenylenediamine, available from ICI Rubber Chemicals, Calcutta, India. Other suitable secondary aryl amines include 4,4′-bis(α,α′-tertiaryoctyl)diphenylamine, 4,4′-bis(α-methylbenzhydryl)diphenylamine, and others from EP 0509282 B1.

The hindered amine light stabilizers (HALS) may be one or more hindered amine type light stabilizers (HALS). HALS are compounds of the following general formulas and combinations thereof:

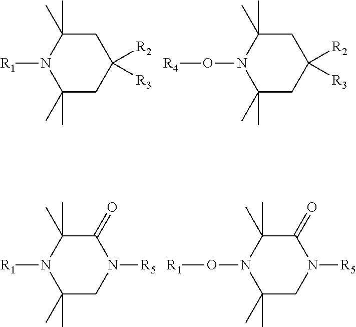

In these formulas, R₁ up to and including R₅ are independent substituents. Examples of suitable substituents are hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. A hindered amine light stabilizer may also form part of a polymer or oligomer.

Preferably, the HALS is a compound derived from a substituted piperidine compound, in particular any compound derived from an alkyl-substituted piperidyl, piperidinyl or piperazinone compound, and substituted alkoxypiperidinyl compounds. Examples of such compounds are: 2,2,6,6-tetramethyl-4-piperidone; 2,2,6,6-tetramethyl-4-piperidinol; bis-(1,2,2,6,6-pentamethyl hydroxybenzyl) butylmalonate; di-(2,2,6,6-tetramethyl-4-piperidyl) sebacate (Tinuvin® 770, MW 481); oligomer of N-(2-hydroxyethyl)-2,2,6,6-tetramethyl-4-piperidinol and succinic acid (Tinuvin® 622); oligomer of cyanuric acid and N,N-di(2,2,6,6-tetramethyl-4-piperidyl)-hexamethylene diamine; bis-(2,2,6,6-tetramethyl-4-piperidinyl) succinate; bis-(1-octyloxy-2,2,6,6-tetramethyl-4-piperidinyl) sebacate (Tinuvin® 123); bis-(1,2,2,6,6-pentamethyl-4-piperidinyl) sebacate (Tinuvin® 765); Tinuvin® 144; Tinuvin® XT850; tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinamine; 2,2′-[(2,2,6,6-tetramethyl-piperidinyl)-imino]-bis-[ethanol]; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); 8-acetyl-3-dothecyl-7,7,9,9-tetramethyl-1,3,8-triazaspiro(4,5)decane-2,4-dione; polymethylpropyl-3-oxy-[4(2,2,6,6-tetramethyl)-piperidinyl]siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl) maleimide and N-stearyl maleimide; 1,2,3,4-butanetetracarboxylic acid, polymer with beta,beta′,beta′-tetramethyl-2,4,8,10-tetraoxaspiro[5.5]undecane-3,9-diethanol, 1,2,2,6,6-pentamethyl-4-piperidinyl ester (Mark® LA63); 2,4,8,10-tetraoxaspiro[5.5]undecane-3,9-diethanol,beta,beta,beta′,beta′-tetramethyl-polymer with 1,2,3,4-butanetetracarboxylic acid, 2,2,6,6-tetramethyl-4-piperidinyl ester (Mark® LA68); D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosan-21-one-2,2,4,4-tetramethyl-20-(oxiranylmethyl) (Hostavin® N30); propanedioic acid, [(4-methoxyphenyl)methylene]-,bis(1,2,2,6,6-pentamethyl-4-piperidinyl) ester (Sanduvor® PR 31); formamide, N,N′-1,6-hexanediylbis[N-(2,2,6,6-tetramethyl-4-piperidinyl (Uvinul® 4050H); 1,3,5-triazine-2,4,6-triamine, N,N′″-[1,2-ethanediylbis[[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb® 119 MW 2286); poly[[6-[(1,1,3,33-tetramethylbutyl)amino]-1,3,5-triazine-2,4-diy][(2,2,6,6-tetramethyl-4-peperidinyl)-imino]-1,6-hexanediyl[(2,2,6,6-tetramethyl-4-piperidinyl)imino]] (Chimassorb® 944 MW 2000-3000); 1,5-dioxaspiro(5,5) undecane 3,3-dicarboxylic acid, bis(2,2,6,6-tetramethyl-4-peridinyl) ester (Cyasorb®UV-500); 1,5-dioxaspiro(5,5) undecane 3,3-dicarboxylic acid, bis(1,2,2,6,6-pentamethyl-4-peridinyl) ester (Cyasorb® UV-516); N-2,2,6,6-tetramethyl-4-piperidinyl-N-amino-oxamide; 4-acryloyloxy-1,2,2,6,6-pentamethyl-4-piperidine. 1,5,8,12-tetrakis[2′,4′-bis(1″,2″,2″,6″,6″-pentamethyl-4″-piperidinyl(butyl)amino)-1′,3′,5′-triazine-6′-yl]-1,5,8,12-tetraazadodecane; HALS PB-41 (Clariant Huningue S. A.); Nylostab® S-EED (Clariant Huningue S. A.); 3-dodecyl-1-(2,2,6,6-tetramethyl-4-piperidyl)-pyrrolidin-2,5-dione; Uvasorb® HA88; 1,1′-(1,2-ethane-di-yl)-bis-(3,3′,5,5′-tetra-methyl-piperazinone) (Good-rite® 3034); 1,1′1″-(1,3,5-triazine-2,4,6-triyltris((cyclohexylimino)-2,1-ethanediyl)tris(3,3,5,5-tetramethylpiperazinone) (Good-rite® 3150) and; 1,1′,1″-(1,3,5-triazine-2,4,6-triyltris((cyclohexylimino)-2,1-ethanediyl)tris(3,3,4,5,5-tetramethylpiperazinone) (Good-rite® 3159). (Tinuvin® and Chimassorb® materials are available from Ciba Specialty Chemicals; Cyasorb® materials are available from Cytec Technology Corp.; Uvasil® materials are available from Great Lakes Chemical Corp.; Saduvor®, Hostavin®, and Nylostab® materials are available from Clariant Corp.; Uvinul® materials are available from BASF; Uvasorb® materials are available from Partecipazioni Industriali; and Good-rite® materials are available from B.F. Goodrich Co. Mark® materials are available from Asahi Denka Co.)

Other specific HALS are selected from the group consisting or di-(2,2,6,6-tetramethyl-4-piperidyl) sebacate (Tinuvin® 770, MW 481) Nylostab® S-EED (Clariant Huningue S. A.); 1,3,5-triazine-2,4,6-triamine, N,N′″-[1,2-ethanediylbis [[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb® 119 MW 2286); and poly[[6-[(1,1,3,33-tetramethylbutyl)amino]-1,3,5-triazine-2,4-diyl][(2,2,6,6-tetramethyl-4-peperidinyl)-imino]-1,6-hexanediyl[(2,2,6,6-tetramethyl-4-piperidinyl)imino]] (Chimassorb® 944 MW 2000-3000).

Mixtures of secondary aryl amines and HALS may be used. A preferred embodiment comprises at least two co-stabilizers, at least one selected from the secondary aryl amines; and at least one selected from the group of HALS, as disclosed above, wherein the total weight percent of the mixture of co-stabilizers is at least 0.5 wt percent, and preferably at least 0.9 weight percent.

By hindered phenol is meant an organic compound containing at least one phenol group wherein the aromatic moiety is substituted at least at one and preferably at both positions directly adjacent to the carbon having the phenolic hydroxyl group as a substituent. The substituents adjacent the hydroxyl group are alkyl radicals suitably selected from alkyl groups having from 1 to 10 carbon atoms, and preferably will be tertiary butyl groups. The molecular weight of the hindered phenol is suitably at least about 260, preferably at least about 500, more preferably at least about 600. Most preferred are hindered phenols having low volatility, particularly at the processing temperatures employed for molding the formulations, and may be further characterized as having a 10% TGA weight loss temperature of at least 290° C., preferably at least 300° C., 320° C., 340° C., and most preferably at least 350° C.

Suitable hindered phenol compounds include, for example, tetrakis(methylene (3,5-di-(cert)butyl-4-hydroxyhydrocinnamate)) methane, available commercially as Irganox® 1010 from CIBA Specialty Chemicals, Tarrytown, N.Y. and N,N′-hexamethylene bis(3,5-di-(tert)butyl-hydroxyhydro-cinnamamide) also available from CIBA Specialty Chemicals as Irganox® 1098. Other suitable hindered phenols include 1,3,5-trimethyl-2,4,6-tris(3,5-di-(tert)-butyl-4-hydroxybenzyl)benzene and 1,6hexamethylene bis(3,5-di-(tert)butyl-4-hydroxy hydrocinnamate), both available from CIBA Specialty Chemicals as Irganox® 1330 and 259, respectively. A preferred co-stabilizer for the polyamide composition is a hindered phenol. Irganox 1098 is a most preferred hindered phenol for the compositions.

Mixtures of polyhydric alcohols, secondary aryl amines, hindered phenols, and HALS may be used. A preferred embodiment includes at least one polyhydric alcohol and at least one secondary aryl amine in the weight ranges defined above.

The thermoplastic composition may comprise about 0.1 to at or about 1 weight percent, or more preferably from at or about 0.1 to at or about 0.7 weight percent, based on the total weight of the polyamide composition, of copper salts. Copper halides are mainly used, for example CuI, CuBr, Cu acetate and Cu naphthenate. Cu halides in combination with alkali halides such as KI, KBr or LiBr may be used. Copper salts in combination with at least one other stabilizer selected from the group consisting of poyhydric alcohols, polyhydric polymers, secondary aryl amines and HALS; as disclosed above, may be used as thermal stabilizers.

In one embodiment 0.1 to 3.0 weight percent of one or more colorants is present, wherein the weight percent colorant includes the weight of the carrier accompanying the colorant. In one embodiment the colorant is selected from the group of carbon black and nigrosine black pigment.

Herein the melt-blended thermoplastic composition is compounded by a melt-blending method, in which the ingredients are appropriately dispersed in a polymer matrix during the compounding process. Any melt-blending method may be used for mixing the ingredients and the polymeric materials of the present invention. For example, polymeric material and the ingredients may be fed into a melt mixer through a single feeder or multiple feeders of a single screw extruder or twin screw extruder, agitator, kneader, or Banbury mixer, and the addition of all the components may be carried out in a single cycle process or by batch process in a multiple cycles. When the polymeric material and different ingredients are added in batches in multiple cycles, a part of the polymeric material and/or ingredients are first melt blended, and in subsequent stages melt blended products are further melt-mixed with the remaining polymeric materials and/or ingredients until an adequately mixed composition is obtained. If a reinforcing filler presents a long physical shape (for example, a long glass fiber), drawing extrusion molding or pultrusion process may be used to prepare a reinforced composition.

In another aspect, the present invention relates to a method for manufacturing an article by shaping the melt-mixed compositions. Examples of articles are monolayer tubes, hoses, pipes, particularly those useful in automobile manufacturing. By “shaping”, it is meant any shaping technique, such as for example extrusion, injection molding, thermoform molding, compression molding, blow molding, or film blowing. Preferably, the article is shaped by extrusion or injection molding.

### Methods

### Melting Point

Herein melting points were as determined with DSC at a scan rate of 10° C./min in the first heating scan, wherein the melting point is taken at the maximum of the endothermic peak.

### Freezing Point

Herein freezing points were as determined with DSC at a scan rate of 10° C./min in the cooling cycle as per ASTM D3418.

### Inherent Viscosity

Inherent viscosity (IV) was measured on a 0.5% solution of copolyamide in m-cresol at 25° C.

### Mechanical Properties

Polyamides obtained from single preparation batches or multiple preparation batches (2 to 3 batches) were cube blended, dried and then injection molded into test bars. The tensile and flexural properties listed in Table 1 were measured as per ASTM D638 and ASTM D790 test procedures, respectively. Yield stress and Young's modulus were measured using 115 mm (4.5 in) long and 3.2 mm (0.13 in) thick type IV tensile bars per ASTM D638-02a test procedure with a crosshead speed of 50 mm/min (2 in/min). Flexural modulus was measured using 3.2 mm (0.13 in) thick test pieces per ASTM D790 test procedure with a 50 mm (2 in) span, 5 mm (0.2 in) load and support nose radii and 1.3 mm/min (0.05 in/min) crosshead speed.

### DMA Test Method

Dynamic mechanical analysis (DMA) test was done using TA instruments DMA Q800 equipment. Injection molded test bars nominally measuring 18 mm×12.5 mm×3.2 mm were used in single cantilever mode by clamping their one end. The bars were equilibrated to −140° C. for 3 to 5 minutes, and then DMA test was carried out with following conditions: temperature ramping up from −140° C. to +150° C. at a rate of 2 degrees C./min, sinusoidal mechanical vibration imposed at an amplitude of 20 micrometers and multiple frequencies of 100, 50, 20, 10, 5, 3 and 1 Hz with response at 1 Hz selected for determination of storage modulus (E′) and loss modulus (E″) as a function of temperature. Tan delta was computed by dividing the loss modulus (E″) by the storage modulus (E′).

### Zinc Chloride Resistance Test

ASTM D1693, Condition A, provides a test method for determination of environmental stress-cracking of ethylene plastics in presence of surface active agents such as soaps, oils, detergents etc. This procedure was adapted for determining stress cracking resistance of the polyamide compositions to a 50% by weight aqueous solution of ZnCl2 as follows.

Rectangular test pieces measuring 37.5 mm×12 mm×3.2 mm were molded. A controlled nick was cut into the face of each molded bar as per the standard procedure, the bars were bent into U-shape with the nick facing outward, and positioned into brass specimen holders as per the standard procedure. At least five bars were used for each composition. The holders were positioned into large test tubes.

The test fluid used was 50 wt % zinc chloride solution prepared by dissolving anhydrous zinc chloride into water in 50:50 weight ratio. The test tubes containing specimen holders were filled with freshly prepared salt solution fully immersing the test pieces such that there was at least 12 mm of fluid above the top test piece. The test tubes were positioned upright in a circulating air oven maintained at 50° C. Test pieces were periodically examined for development of cracks over a period up to about 8 days. The time to first observation of failure in any of the test pieces was recorded. After 191 hours of continued immersion, test pieces were withdrawn from the zinc chloride solution and without wiping, dried in an oven at 50° C. for another 24 hours.

### Tube Extrusion & Burst Pressure Testing Method

Impact modified melt blended compositions comprising polymer tougheners are dried overnight in a dehumidifying dryer at 65° C. They are extruded into tubes measuring 8.3 mm OD×6.3 mm ID using a Davis Standard tube extrusion system. The system consists of a 50 mm single screw extruder equipped with a tubing die, a vacuum sizing tank with a plate style calibrator, puller and cutter. Die with bushing of 15.2 mm (0.600 in) and a tip of 8.9 mm (0.350 in) is used. Calibrator is 8.3 mm (0.327 in). Extruder barrel temperature profile is about 210° C. at the feed port increasing to about 230° C. at the die. Line speed is typically 4.6 m/min (15 ft/min). After establishing a stable process, tubing is cut to 30 cm long pieces and used for burst pressure measurements.

Tube burst pressure is measured using a manual hydraulic pump fitted with a pressure gauge. One end of the tube is attached to the pump using a Swagelok fitting, while the other end of the tube is capped off. The burst pressure is measured by manually raising the fluid pressure until failure. Burst pressure at 125° C. is measured similarly by positioning the tube in a heated air circulating oven and allowing it to equilibrate to temperature for several hours prior to testing. Averages of 3 samples are typically taken.

### Materials

The following polyamides were prepared by synthesis:

### PA 614

Salt Preparation: A 10 L autoclave was charged with tetradecanedioic acid (2690 g), an aqueous solution containing 78.4 weight % of hexamethylene diamine (HMD) (1554 g), an aqueous solution containing 28 weight percent acetic acid (30 g), an aqueous solution containing 1 weight percent sodium hypophosphite (35 g), an aqueous solution containing 1 weight percent Carbowax 8000 (10 g), and water (2260 g).

Process Conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 240° C. The pressure was then reduced to 0 psig over about 45 minutes. During this time, the temperature of the contents rose to 255° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

### PA 616

A 10 L autoclave was charged with hexadecanedioic acid (2543 g), an aqueous solution containing 78.4 weight % of hexamethylene diamine (HMD) (1327 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2630 g).

The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 240° C. The pressure was then reduced to 0 psig over about 45 minutes. During this time, the temperature of the contents rose to 255° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The co-polyamide obtained had an inherent viscosity (IV) of 1.00 dl/g. The polymer had a melting point of 207° C., as measured by DSC.

### PA 618

A 10 L autoclave was charged with octadecanedioic acid (2610 g), an aqueous solution containing 78.4 weight % of hexamethylene diamine (HMD) (1240 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2650 g). The process conditions were the same as that described above for PA616.

The co-polyamide obtained had an inherent viscosity (IV) of 1.15 dl/g. The polymer had a melting point of 199° C., as measured by DSC.

PA610 refers to Zytel® RS3090 polyamide 610 made from 1,6-diaminohexane and 1,10-decanedioic acid having a melting point of 224° C., available from E.I. DuPont de Nemours and Company, Wilmington, Del., USA.

PA612 refers to Zytel® 158 NC010 resin, having a melting point of about 218° C., available from E. I. du Pont de Nemours and Company, Wilmington, Del.

PA1010 refers to Zytel® FE110004 polyamide 1010 made from 1,10-decanedioic acid and 1,10-daiminodecane available from E.I. DuPont de Nemours and Company, Wilmington, Del., USA.

Uniplex® 214 plasticizer,refers to N-butylbenzenesulfonamide available from Unitex Chemical Corp., Greensboro, N.C.

Fusabond® N598 is a maleic anhydride grafted ethylene copolymer, available from E.I. DuPont de Nemours and Company, Wilmington, Del., USA.

Additives:

Carbon black refers to ZYTEMCB32 BK035C black master batch consisting of 45 weight percent carbon black in an ethylene/methacrylic acid copolymer available from Ampacet Corporation, Tarrytown, N.Y.

Licomont® CaV 102 fine grain is calcium salt of montanic acid available from Clariant Corp., 4132 Mattenz, Switzerland.

Naugard® 445 stabilizer refers to 4,4′di(.α,α-dimethylbenzyl)diphenylamine available commercially from Chemtura Chemical Company, Middlebury, Conn.

Lowinox® 44B25 is an antioxidant obtained from Great Lakes Chemical Corporation.

Irgafos® 168 stabilizer is a phosphite anti-oxidant from BASF.

TABLE 1
Properties of PA614, PA616 and PA 618 homopolyamides

| | | | |
|---|---|---|---|
| Polymer | PA614 | PA616 | PA 618 |

DSC data

| | | | |
|---|---|---|---|
| Melting point (° C.) | 213 | 207 | 192 |
| Heat of fusion (J/g) | 62 | 65 | 67 |
| Freezing point (° C.) | 179 | 180 | 164 |
| Delta T (MP − FP) (° C.) | 34.2 | 27 | 28 |

DMA data

| | | | |
|---|---|---|---|
| Storage modulus, 23° C. | 1781 | 1473 | 1355 |
| (MPa) | | | |
| Storage modulus, 125° C. | 323 | 280 | |
| (MPa) | | | |
| Tan delta Peak Temp (° C.) | 59 | 60 | 53 |
| Tan delta peak value | 0.11 | 0.11 | 0.12 |

Mechanical properties

| | | | |
|---|---|---|---|
| TS, 23° C. (MPa) | 52 | 50 | 45 |
| Flex Modulus (Mpa) | 1938 | 1781 | 1475 |
| TM, 23° C. (MPa) | 1805 | 1697 | 1534 |
| TM, 125° C.(MPa) | 267 | 243 | |

Salt stress crack resistance

| | | | |
|---|---|---|---|
| Hours to failure at 50 C., | >95, failure | No failures | No failures |
| 50% ZnCl2 solution | at 167 h^{a} | to 191 h, | to 191 h and |
| | | failure after | 24 h drying |
| | | 24 h drying | |

^{a}no observation available between 95 h and 167 h

TABLE 2
Properties of Thermoplastic Compositions including PA 614 and PA 616.

| Example | C-1 | C-2 | C-3 | 1 | 2 |
|---|---|---|---|---|---|
| PA610 (wt %) | 66.5 | | | | |
| PA612 (wt %) | | 66.5 | | | |
| PA1010 (wt %) | | | 66.5 | | |
| PA614 (wt %) | | | | 66.5 | |
| PA616 (wt %) | | | | | 66.5 |
| Fusabond N598 (wt %) | 23 | 23 | 23 | 23 | 23 |
| Uniplex 214 (wt %) | 7 | 7 | 7 | 7 | 7 |
| Additives (wt %) | 3.5 | 3.5 | 3.5 | 3.5 | 3.5 |
| Tan Delta Peak Temp (° C.) | 45.3 | 44.3 | 26.5 | 30.3 | 23.2 |
| Tan Delta Peak Value | 0.13 | 0.11 | 0.12 | 0.11 | 0.10 |
| Storage modulus @ 23° C. (MPa) | 715 | 796 | 597 | 676 | 576 |
| Storage modulus @ 125° C. (MPa) | 116 | 149 | 102 | 141 | 118 |
| Tensile modulus @ 23° C. (MPa) | 646 | 726 | 459 | 641 | 516 |
| Tensile modulus @ 125° C. (Mpa) | 120 | 141 | 101 | 133 | 112 |
| Yield stress @ 23° C. max load (Mpa) | 46 | 37 | 42 | 33 | 33 |
| Burst Pressure @ 23° C. (bars) | 106 | 108 | 88 | 103 | 85 |
| Burst Pressure @ 125° C. (bars) | 30 | 27 | 23 | 26 | 27 |
| Hours to failure at 50° C., 50% ZnCl₂ | 6 | >6, failure at | No failure to 144 | No failures to | No failures to |
| | | 23 h^{a} | h, failure after | 144 h and 25 h | 144 h and 25 h |
| | | | 25 h drying | drying | drying |

Additives = 2% ZYTEMCB32 BK035C carbon black, 0.5% Naugard 445, 0.5% Lowinox 44B25 and 0.5% IRGAFOS 168.
^{a}no observation available between 6 and 23 h.

1. A monolayer tube comprising a melt-blended thermoplastic composition consisting essentially of:
(A) 40 to 100 weight percent of a polyamide resin selected from poly(hexamethylene hexadecanediamide);
(B) 0 to 30 weight percent of one or more polymeric toughener(s);
(C) 0 to 20 weight percent, of one or more plasticizer(s);
(D) 0 to 10 weight percent of one or more functional additive(s);
wherein the weight percent of (A), (B), (C), and (D) are based on the total weight of the melt-blended thermoplastic composition.

2. (canceled)

3. (canceled)

4. (canceled)

5. The monolayer tube of claim 1 wherein 2 to 25 weight percent one or more polymeric toughener(s) is present.

6. The monolayer tube of claim 1 wherein about 1 to about 20 weight percent plasticizer is present.

7. A monolayer tube comprising a melt-blended thermoplastic composition consisting essentially of:
(A) 40 to 100 weight percent of a polyamide resin selected from the group consisting of poly(hexamethylene tetradecanediamide), poly(hexamethylene hexadecanediamide), poly(hexamethylene octadecanediamide), and blends thereof;
(B) 0.5 to 30 weight percent of at least one polymeric toughener selected from the group consisting of:
(i) copolymers of ethylene, glycidyl (meth)acrylate, and optionally one or more (meth)acrylate esters;
(ii) ethylene/α-olefin copolymers, ethylene/α-olefin/diene copolymers, or mixtures thereof, grafted with an unsaturated carboxylic anhydride;
(iii) copolymers of ethylene,2-isocyanatoethyl (meth)acrylate, and optionally one or more (meth)acrylate esters;
(iv) copolymers of ethylene and acrylic acid reacted with a compound having Zn, Li, Mg, or Mn, to form the corresponding ionomer;
(C) 0 to 20 weight percent of one or more plasticizer(s); and
(D) 0 to 10 weight percent of one or more functional additive(s);
wherein the monolayer tube has a salt stress crack resistance of at least 144 hours without failure, as measured by ASTM D1693, with the proviso that a 50 weight percent zinc chloride solution is used, and the test is conducted at 50° C. using test pieces measuring 37.5 mm×12 mm×3.2 mm; and the weight percent of (A), (B), (C), and (D) are based on the total weight of the melt-blended thermoplastic composition.

8. The monolayer tube of claim 7, wherein the unsaturated carboxylic anhydride is maleic anhydride.

9. The monolayer tube of claim 7 consisting essentially of 2 to 30 weight percent of the polymeric toughener.

10. The monolayer tube of claim 7 consisting essentially of 8 to 30 weight percent of the polymeric toughener.

11. The monolayer tube of claim 7 consisting essentially of 8 to 25 weight percent of the polymeric toughener.

12. The monolayer tube of claim 1, wherein tube has a salt stress crack resistance of at least 144 hours without failure, as measured by ASTM D1693, with the proviso that a 50 weight percent zinc chloride solution is used, and the test is conducted at 50° C. using test pieces measuring 37.5 mm×12 mm×3.2 mm.

13. The monolayer tube of claim 1, wherein the polyamide resin has at least one bio-sourced aliphatic dioic acid or aliphatic diamine.

14. The monolayer tube of claim 7, wherein the polyamide resin has at least one bio-sourced aliphatic dioic acid or aliphatic diamine.

15. The monolayer tube of claim 1, wherein the polyamide resin has at least one bio-sourced aliphatic dioic acid and aliphatic diamine.

16. The monolayer tube of claim 7, wherein the polyamide resin has at least one bio-sourced aliphatic dioic acid and aliphatic diamine.
